(19) United States
(12) Patent Application Publication
(10) Pub. No.: US 2011/0128096 A1
(43) Pub. Date: Jun. 2, 2011

(54) SYSTEM AND METHOD FOR MODIFYING HAIRPIN FILTER, AND HAIRPIN FILTER

(75) Inventors: Bong-Su KIM, Daejeon (KR); Kwang Seon Kim, Daejeon (KR); Min Soo Kang, Daejeon (KR); Woo Jin Byun, Daejeon (KR); Myung Sun Song, Daejeon (KR)

(73) Assignee: ELECTRONICS AND TELECOMMUNICATIONS RESEARCH INSTITUTE, Daejeon (KR)

(21) Appl. No.: 12/828,185

(22) Filed: Jun. 30, 2010

(30) Foreign Application Priority Data
Nov. 30, 2009 (KR) 10-2009-0116652

(51) Int. Cl. H01P 1/203

(52) U.S. Cl. 333/204

(57) ABSTRACT

A system for modifying a hairpin filter is provided which includes a structure transformer to divide a hairpin filter into a plurality of filters and to arrange the plurality of filters in a bilaterally symmetrical pattern, and a coupling generator to generate a plurality of coupling lines, each of the plurality of coupling lines being between each of the filters.

### CROSS-REFERENCE TO RELATED APPLICATION

This application claims the benefit of Korean Patent Application No. 10-2009-0116652, filed on Nov. 30, 2009, in the Korean Intellectual Property Office, the disclosure of which is incorporated herein by reference.

### BACKGROUND

1. Field of the Invention

The present invention relates to a system and method for modifying a hairpin filter, and a hairpin filter.

2. Description of the Related Art

In wireless communication transceivers, filters are typically used to remove undesired signals around wireless communication transceivers. Currently, a large number of studies on filters are being conducted and as a result, filters have a variety of forms.

Among these filters, a hairpin type filter (hereinafter, is referred to as a “hairpin filter”) is most frequently used. Since a hairpin filter is enabled to have a small size in a system where a size of a filter is important, a hairpin filter is preferred over other forms.

FIG. 1 is a diagram illustrating a structure of a conventional hairpin filter, and FIG. 2 is a graph illustrating a result of a simulation using the conventional hairpin filter of FIG. 1.

Specifically, FIG. 1 illustrates a layout of a quintic Chebyshev type hairpin filter having a frequency bandwidth of 1 GHz in a band of 9 GHz. FIG. 2 illustrates a result of an electromagnetic (EM) simulation for the conventional hairpin filter of FIG. 1.

As shown in FIG. 2, an upstream frequency band and a downstream frequency band in a pass band exhibit linear attenuation characteristics. However, conventionally, there was no appropriate method for removing undesired signals in adjacent frequency band. In other words, when a higher mode of a LO signal in the adjacent frequency band occurs, or when influences of adjacent channels in a multi-channel structure may need to be eliminated, attenuation characteristics in an immediately adjacent frequency band may become important.

### SUMMARY

An aspect of the present invention provides a hairpin filter that may remove an undesired signal near an adjacent frequency band by forming a new transmission zero through a structural transformation of a conventional hairpin filter while maintaining advantages of compactness of the conventional hairpin filter.

Another aspect of the present invention provides a system and method for modifying a hairpin filter that may divide a conventional hairpin filter into a plurality of filters on both sides of the center of the conventional hairpin filter, and may arrange the plurality of filters in a bilaterally symmetrical pattern, so that a transmission zero may be formed on both sides of a pass band.

According to an aspect of the present invention, there is provided a system for modifying a hairpin filter, the system including a structure transformer to divide a hairpin filter into a plurality of filters and to arrange the plurality of filters in a bilaterally symmetrical pattern, and a coupling generator to generate a plurality of coupling lines, each of the plurality of coupling lines being between each of the filters.

The coupling generator may generate the coupling lines between far ends of transmission lines or between center lines, the transmission lines and the center lines being in the filters.

The system may further include a frequency modifier to modify an attenuation frequency by adjusting a parameter value that is associated with the generated coupling lines.

The frequency modifier may modify a first attenuation frequency by adjusting a parameter value that is associated with a length between each of the coupling lines.

The frequency modifier may modify a second attenuation frequency by adjusting another parameter value that is associated with a length between each of the filters.

When a first attenuation frequency and a second attenuation frequency are simultaneously modified, the frequency modifier may adjust the parameter value. Here, the parameter value and the first attenuation frequency may be associated with a length between each of the coupling lines, and the second attenuation frequency may be associated with a length between each of the filters.

According to another aspect of the present invention, there is provided a hairpin filter in which a plurality of filters are arranged in a bilaterally symmetrical pattern, and a plurality of coupling lines are respectively generated between each of the plurality of filters. Here, the plurality of filters may be obtained by dividing the hairpin filter.

According to still another aspect of the present invention, there is provided a method for modifying a hairpin filter, the method including dividing a hairpin filter into a plurality of filters and arranging the plurality of filters in a bilaterally symmetrical pattern, generating a plurality of coupling lines, each of the plurality of coupling lines being between each two of the filters, and modifying an attenuation frequency by adjusting a parameter value, the parameter value being associated with the generated coupling lines.

### EFFECT

According to embodiments of the present invention, a process of designing a conventional hairpin filter may be used without any change and thus, it is possible to reduce a time required to design a hairpin filter, and to maintain advantages of compactness.

Additionally, according to embodiments of the present invention, a new transmission zero may be formed through a simple structural transformation of a conventional hairpin filter and thus, it is possible to easily remove an undesired signal in an adjacent frequency band.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of a conventional hairpin filter;

FIG. 2 is a graph illustrating a result of a simulation using the conventional hairpin filter of FIG. 1;

FIG. 3 is a block diagram illustrating an internal configuration of a hairpin filter modification system according to an embodiment of the present invention;

FIG. 4 is a diagram illustrating a structure of a hairpin filter according to an embodiment of the present invention;

FIG. 5 is a graph illustrating a result of a simulation using the hairpin filter of FIG. 4;

FIGS. 6 through 8 are graphs illustrating results of simulations using a hairpin filter according to the present invention;

FIGS. 9 through 11 are diagrams illustrating a structure of a hairpin filter according to another embodiment of the present invention; and

FIG. 12 is a flowchart illustrating a method of modifying a hairpin filter according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

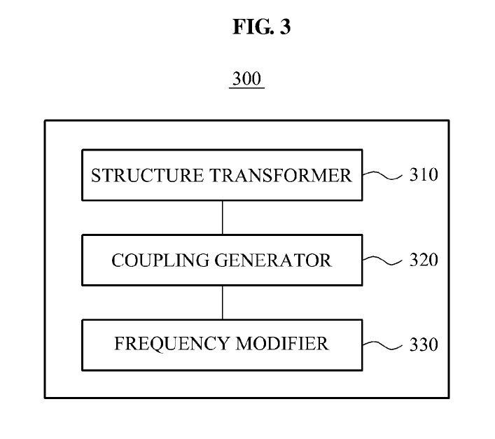

FIG. 3 is a block diagram illustrating an internal configuration of a hairpin filter modification system 300 according to an embodiment of the present invention.

The hairpin filter modification system 300 may include a structure transformer 310, a coupling generator 320, and a frequency modifier 330, as shown in FIG. 3.

The structure transformer 310 may divide a hairpin filter into a plurality of filters, and may arrange the plurality of filters in a bilaterally symmetrical pattern.

For example, the structure transformer 310 may divide a hairpin filter into two filters, and may arrange the two filters in a bilaterally symmetrical pattern. In other words, the structure transformer 310 may fold the hairpin filter so that the two filters may be symmetrical on both sides of the center of the hairpin filter.

The coupling generator 320 may generate a plurality of coupling lines. Here, each of the plurality of coupling lines may be generated between each of the filters formed in the bilaterally symmetrical pattern.

Additionally, the coupling generator 320 may generate the plurality of coupling lines between far ends of transmission lines or between center lines. Here, the transmission lines and the center lines may be placed in the filters. For example, the coupling generator 320 may form a single or a plurality of coupling characteristics for filters by various schemes of using a coupling between center lines, or using a coupling between far ends of transmission lines, or using both of the two couplings.

As described above, the hairpin filter modified by the hairpin filter modification system 300 may be configured to be foldable so that both sides of the center of the hairpin filter may be symmetrical. Additionally, in the hairpin filter, coupling lines may be generated between each of the filters, to show new coupling characteristics. Accordingly, the hairpin filter may form a band stop characteristic, to easily remove a signal in an undesired band.

The frequency modifier 330 may modify an attenuation frequency by adjusting a parameter value that is associated with the generated coupling lines.

For example, the frequency modifier 330 may modify a first attenuation frequency by adjusting a first parameter value that is associated with a length between each of the coupling lines.

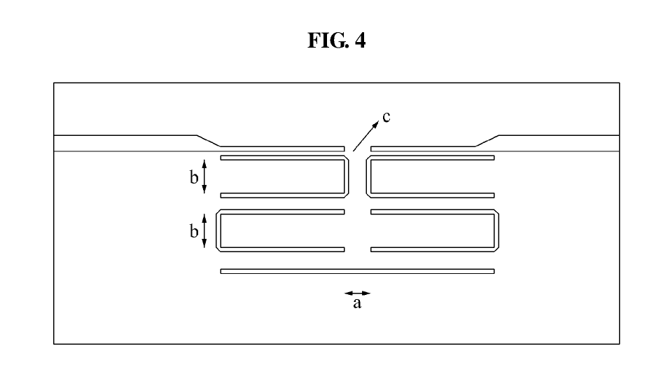

Referring to FIG. 4, the frequency modifier 330 may change the first parameter value “b” that is associated with a length between each of the coupling lines, and may simply modify the first attenuation frequency. Here, it is advantageous that other frequencies, for example a second attenuation frequency and a third attenuation frequency, may remain unchanged, even when the first attenuation frequency is modified.

Additionally, the frequency modifier 330 may modify the second attenuation frequency by adjusting a second parameter value that is associated with a length between each of the filters arranged in the bilaterally symmetrical pattern. Here, when the first attenuation frequency and the second attenuation frequency are simultaneously modified, the frequency modifier 330 may adjust the first parameter value associated with the length between each of the coupling lines.

Referring to FIG. 4, the frequency modifier 330 may change the second parameter value “a” that is associated with a length between each of the filters into which the hairpin filter is divided, and may simply modify the second attenuation frequency. Additionally, when modifying the second attenuation frequency, the frequency modifier 330 may further adjust the first parameter value “b,” to modify the first attenuation frequency to a desired frequency.

According to an embodiment of the present invention, it is possible to generate a hairpin filter that may easily remove an undesired signal in an adjacent frequency band by forming a new transmission zero through a simple structural transformation of a conventional hairpin filter while maintaining advantages of compactness of the conventional hairpin filter.

Additionally, according to an embodiment of the present invention, it is possible to generate a hairpin filter that may form a transmission zero on both sides of a passband by dividing a conventional hairpin filter into a plurality of filters on both sides of the center of the conventional hairpin filters and arranging the plurality of filters in a bilaterally symmetrical pattern.

FIG. 4 is a diagram illustrating a structure of a hairpin filter according to an embodiment of the present invention.

The hairpin filter of FIG. 4 may be divided into a plurality of filters, and the plurality of filters may be arranged in the bilaterally symmetric pattern. Additionally, a plurality of coupling lines may be respectively generated between each of the plurality of filters arranged in the bilaterally symmetric pattern.

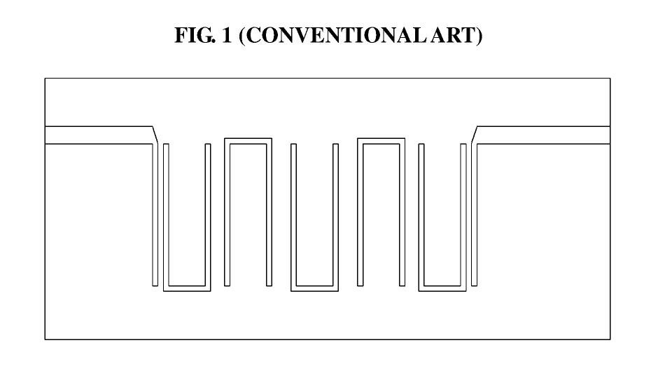

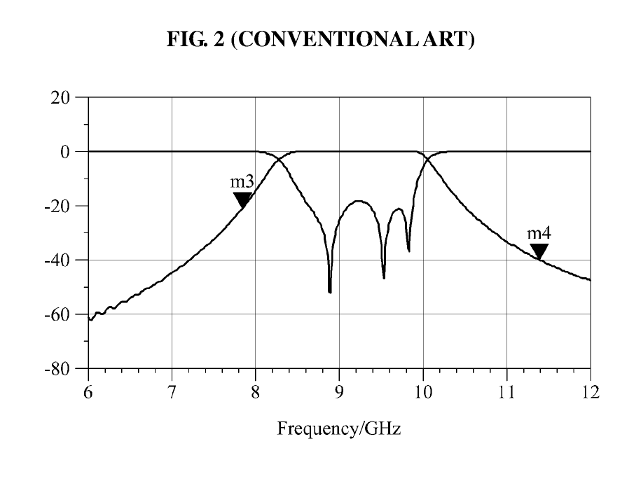

Specifically, the hairpin filter of FIG. 4 may be formed by dividing the conventional hairpin filter of FIG. 1 into a plurality of filters on both sides of the center of the conventional hairpin filter, and by arranging the plurality of filters having bilateral symmetry.

Additionally, in the hairpin filter of FIG. 4, a coupling line may be generated between far ends of transmission lines, or between center lines. In the hairpin filter of FIG. 4 configured as described above, a transmission zero point may be formed in an upstream frequency band or a downstream frequency band in a filter passband. Thus, it is possible to easily remove an undesired signal in an adjacent frequency band.

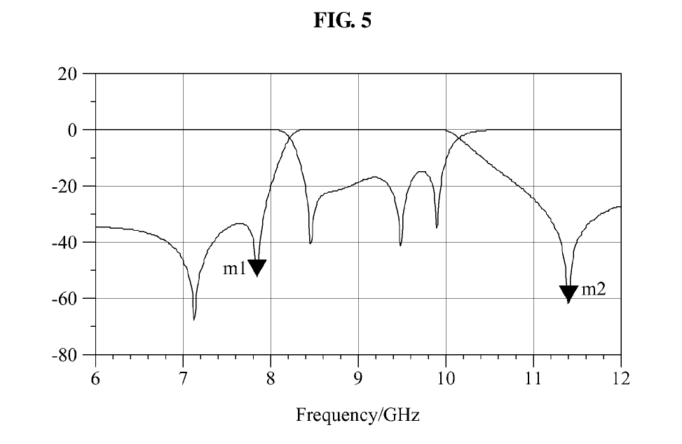

FIG. 5 is a graph illustrating a result of a simulation using the hairpin filter of FIG. 4.

Referring to the graph of FIG. 5, three attenuation points may be formed in a filter passband by the hairpin filter of FIG. 4. Among the three attenuation points, two attenuation points may be formed in a downstream frequency band, and the other one may be formed in an upstream frequency band.

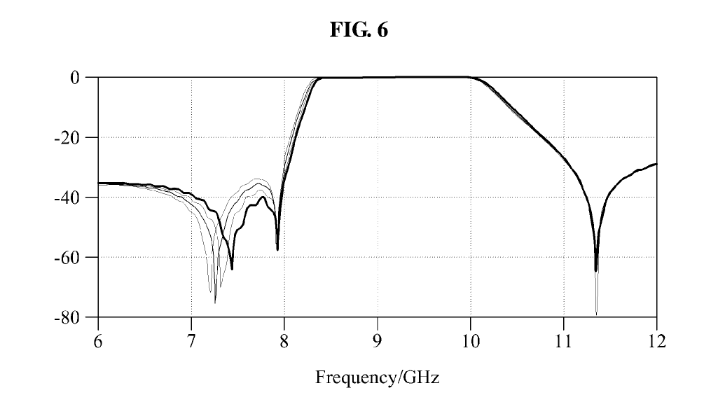

FIGS. 6 through 8 are graphs illustrating results of simulations using a hairpin filter according to the present invention.

As shown in the graph of FIG. 6, to determine a first attenuation frequency, the hairpin filter according to the present invention may simply modify the first attenuation frequency by changing the first parameter value “b” shown in FIG. 4 that is associated with a length between each of the coupling lines. Here, it is advantageous that other frequencies, for example a second attenuation frequency and a third attenuation frequency, may remain unchanged, even when the first attenuation frequency is modified.

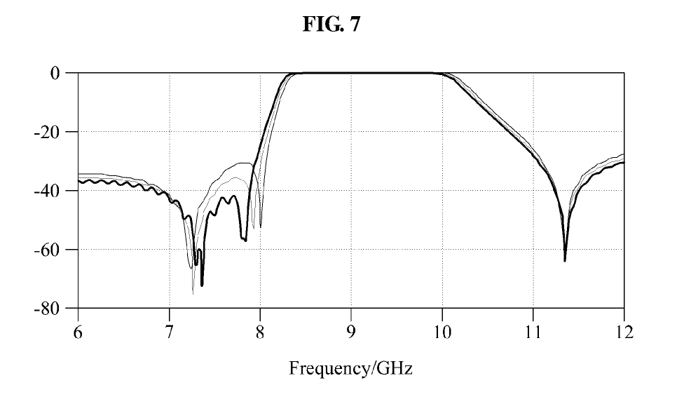

As shown in the graph of FIG. 7, to determine a second attenuation frequency, the hairpin filter according to the present invention may simply modify the second attenuation frequency by changing the second parameter value “a” shown in FIG. 4 that is associated with a length between each of the filters into which the hairpin filter is divided. Here, when the second attenuation frequency is being significantly changed, the first attenuation frequency may be slightly changed. Additionally, the hairpin filter may further adjust the first parameter value “b,” to modify the first attenuation frequency to a desired frequency.

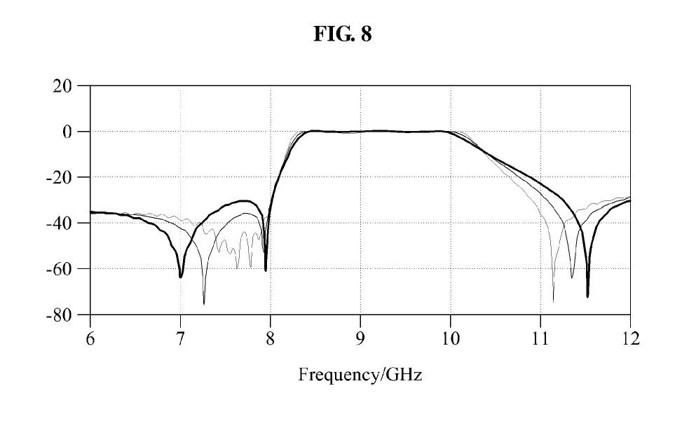

As shown in the graph of FIG. 8, to determine a third attenuation frequency, the hairpin filter according to the present invention may simply modify the third attenuation frequency by changing a third parameter value “c” shown in FIG. 4. Here, the hairpin filter may further adjust the parameter value “b,” to modify the first attenuation frequency to another desired frequency.

As described above, the hairpin filter according to the embodiment of the present invention may modify all of the three attenuation frequencies to desired frequencies. Accordingly, it is possible to simplify a design of a compact hairpin filter having superior attenuation characteristics.

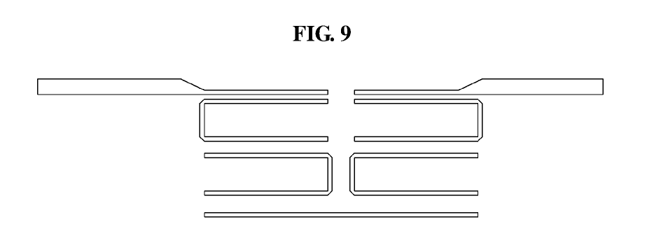

FIGS. 9 through 11 are diagrams illustrating a structure of a hairpin filter according to another embodiment of the present invention.

In the hairpin filter according to the other embodiment of the present invention, various schemes of forming coupling characteristics may be provided, for example, a scheme of using only a coupling between center lines, a scheme of using only a coupling between far ends of transmission lines, and a scheme of using both of the two couplings.

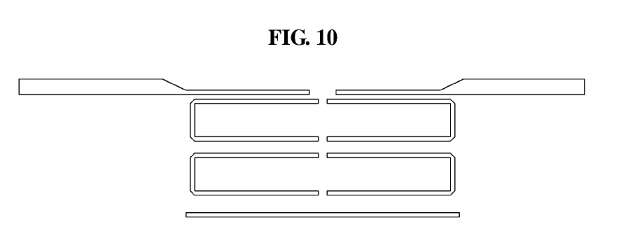

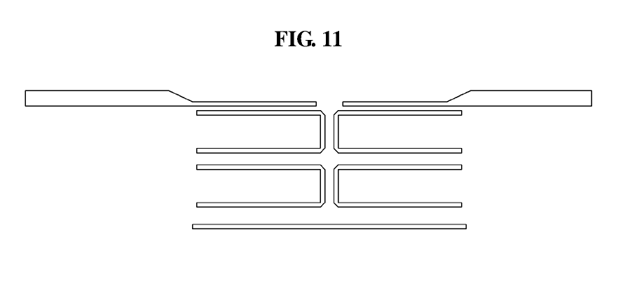

FIG. 9 illustrates an example of forming a coupling characteristic, namely a transmission zero, using both of the coupling between center lines and the coupling between far ends of transmission lines. FIG. 10 illustrates an example of forming a coupling characteristic using the coupling between far ends of transmission lines, and FIG. 11 illustrates an example of forming a coupling characteristic using the coupling between center lines.

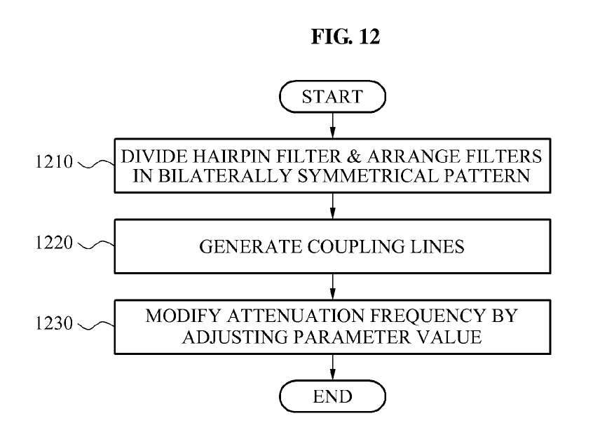

FIG. 12 is a flowchart illustrating a method of modifying a hairpin filter according to an embodiment of the present invention.

The method of modifying a hairpin filter may be performed by the hairpin filter modification system 300 of FIG. 3. Hereinafter, for ease of description, the method of modifying a hairpin filter will be described with reference to FIG. 12 as well as FIG. 3 that has been described above.

In operation 1210, the hairpin filter modification system 300 may divide a hairpin filter into a plurality of filters, and may arrange the plurality of filters in a bilaterally symmetrical pattern.

For example, the structure transformer 310 may divide a hairpin filter into two filters, and may arrange the two filters in a bilaterally symmetrical pattern. In other words, the structure transformer 310 may fold the hairpin filter so that the two filters may be symmetrical on both sides of the center of the hairpin filter.

In operation 1220, the hairpin filter modification system 300 may generate a plurality of coupling lines between each of the filters arranged in the bilaterally symmetrical pattern.

Additionally, the coupling generator 320 may generate the plurality of coupling lines between far ends of transmission lines or between center lines. Here, the transmission lines and the center lines may be placed in the filters. For example, the coupling generator 320 may form a single or a plurality of coupling characteristics for filters by various schemes of using a coupling between center lines, or using a coupling between far ends of transmission lines, or using both of the two couplings.

As described above, the hairpin filter modified by the hairpin filter modification system 300 may be configured to be foldable so that both sides of the center of the hairpin filter may be symmetrical. Additionally, in the hairpin filter, coupling lines may be generated between each of the filters, to show new coupling characteristics. Accordingly, the hairpin filter may form a band stop characteristic, to easily remove a signal in an undesired band.

In operation 1230, the hairpin filter modification system 300 may modify an attenuation frequency by adjusting a parameter value that is associated with the generated coupling lines.

For example, the frequency modifier 330 may modify a first attenuation frequency by adjusting a first parameter value that is associated with a length between each of the coupling lines.

Referring to FIG. 4, the frequency modifier 330 may change the first parameter value “b” that is associated with a length between each of the coupling lines, and may simply modify the first attenuation frequency. Here, it is advantageous that other frequencies, for example a second attenuation frequency and a third attenuation frequency, may remain unchanged, even when the first attenuation frequency is modified.

Additionally, the frequency modifier 330 may modify the second attenuation frequency by adjusting a second parameter value that is associated with a length between each of the filters arranged in the bilaterally symmetrical pattern. Here, when the first attenuation frequency and the second attenuation frequency are simultaneously modified, the frequency modifier 330 may adjust the first parameter value associated with the length between each of the coupling lines.

Referring to FIG. 4, the frequency modifier 330 may change the second parameter value “a” that is associated with a length between each of the filters into which the hairpin filter is divided, and may simply modify the second attenuation frequency. Additionally, when modifying the second attenuation frequency, the frequency modifier 330 may further adjust the first parameter value “b,” to modify the first attenuation frequency to a desired frequency.

According to an embodiment of the present invention, it is possible to generate a hairpin filter that may easily remove an undesired signal in an adjacent frequency band by forming a new transmission zero through a simple structural transformation of a conventional hairpin filter while maintaining advantages of compactness of the conventional hairpin filter.

Additionally, according to an embodiment of the present invention, it is possible to generate a hairpin filter that may form a transmission zero on both sides of a passband by dividing a conventional hairpin filter into a plurality of filters on both sides of the center of the conventional hairpin filters and arranging the plurality of filters in a bilaterally symmetrical pattern.

The above-described exemplary embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for modifying a hairpin filter, the system comprising:
a structure transformer to divide a hairpin filter into a plurality of filters and to arrange the plurality of filters in a bilaterally symmetrical pattern; and
a coupling generator to generate a plurality of coupling lines, each of the plurality of coupling lines being between each of the filters.

2. The system of claim 1, wherein the coupling generator generates the coupling lines between far ends of transmission lines or between center lines, the transmission lines and the center lines being in the filters.

3. The system of claim 1, further comprising:
a frequency modifier to modify an attenuation frequency by adjusting a parameter value, the parameter value being associated with the generated coupling lines.

4. The system of claim 3, wherein the frequency modifier modifies a first attenuation frequency by adjusting a first parameter value, the first parameter value being associated with a length between each of the coupling lines.

5. The system of claim 3, wherein the frequency modifier modifies a second attenuation frequency by adjusting a second parameter value, the second parameter value being associated with a length between each of the filters.

6. The system of claim 3, wherein the frequency modifier adjusts the parameter value, when a first attenuation frequency and a second attenuation frequency are simultaneously modified, the parameter value and the first attenuation frequency being associated with a length between each of the coupling lines, and the second attenuation frequency being associated with a length between each of the filters.

7. A hairpin filter in which a plurality of filters are arranged in a bilaterally symmetrical pattern, and a plurality of coupling lines are respectively generated between each of the plurality of filters, the plurality of filters being obtained by dividing the hairpin filter.

8. A method for modifying a hairpin filter, the method comprising:
dividing a hairpin filter into a plurality of filters, and arranging the plurality of filters in a bilaterally symmetrical pattern;
generating a plurality of coupling lines, each of the plurality of coupling lines being between each of the filters; and
modifying an attenuation frequency by adjusting a parameter value, the parameter value being associated with the generated coupling lines.
